(19) United States
(12) Patent Application Publication
(10) Pub. No.: US 2006/0218829 A1
(43) Pub. Date: Oct. 5, 2006

(54) Moving-loop advertisement device with self stopping and smoothing elements

(76) Inventor: Chris Chen, Chino Hills, CA (US)

Correspondence Address: HERSHKOVITZ & ASSOCIATES, 1725 I STREET NW, SUITE 300, WASHINGTON, DC, 20006, US

(21) Appl. No.: 11/447,273

(22) Filed: Jun. 6, 2006

Related U.S. Application Data
(62) Division of application No. 10/829,360, filed on Apr. 22, 2004.

(51) Int. Cl. G09F 11/12

(52) U.S. Cl. 40/524

(57) ABSTRACT

A moving-loop advertisement device has a rolling screen that surrounds a driving roller and three driven rollers to increase the quantity of the advertisements printed on the rolling screen. A position sensor is applied to detect labels formed on the rolling screen so as to pause the movement of the screen. A coil or helical ribs with opposite twisting directions is further provided on either or both the driving roller and the driven roller. When the rollers start to rotate, the rolling screen is moved upward or downward to sequentially present different advertisement information printed thereon. Meanwhile, as the rotation of the coil or helical ribs, tension forces with opposite directions occur and apply on the rolling screen to maintain the surface of the rolling screen in a smooth flat state.

This application is a division of application Ser. No. 10/829,360, filed Apr. 22, 2004, the contents of which are incorporated herein by reference.

### BACKGROUND OF THE INVENTION

1. Field of the Invention

The present invention relates to a moving-loop advertisement display device, and more particularly to a device that automatically displays and changes pictures for the purpose of demonstrating advertisement information, news announcements etc.

2. Description of Related Art

With reference to FIG. 13, a conventional two-dimensional (2D) image display device has a rolling screen (80) rotatably surrounding a transmission rod (81) and a driven rod (82). The rolling screen (80) can be printed with several pictures, images or slogans as required by the advertisers. While the transmission rod (81) is activated, the rolling screen (80) is able to move upward/downward based on the rotating direction of the transmission rod (81). The rolling screen (80) is thus able to present different patterns. However, with the rotating of the transmission rod (81), wrinkles may gradually occur on the surface of the rolling screen (80) as shown in the drawing. Finally, the whole rolling screen (80) becomes crumpled and can not maintain in its original smooth state, which results in that the considerable efforts spent by manufacturers and advertising agencies in refining the promotion of the product are impaired. Another problem of the image display device is that the rolling screen (80) always keeps rotating. For an advertisement viewer, all these information or pictures on the rolling screen (80) becomes difficult to read.

In addition, since a rolling screen (80) is rotatably surrounding the transmission rod (81) and the driven rod (82), a length of the rolling screen (80) is determined according to a distance between the transmission rod (81) and the driven rod (82). Therefore, the quantity of the advertisements printed on the rolling screen (80) is limited.

Therefore, it is desired to provide a novel advertisement device to obviate the aforementioned drawback.

### SUMMARY OF THE INVENTION

The main objective of the present invention is to provide an advertisement device that allows using a long rolling screen with more advertisements. Further, the present invention drives a rolling screen with advertisement, posters, news, images etc provided thereon as the advertisement, wherein the picture changing device of the present invention utilizes a sensor to detect labels formed on the rolling screen thus to stop the screen at proper positions to demonstrate the advertising content.

Another objective of the present invention is to provide an advertisement device using a transmission device to prevent the occurrence of wrinkles in the rolling sheet while it is rotating.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a moving-loop advertisement display device in accordance with the present invention;

FIG. 2 is a plan view of the moving-loop advertisement display device of FIG. 1;

FIG. 3 is an enlarged perspective view showing an optical sensor of the moving-loop advertisement display of FIG. 1;

FIG. 4 is a cross sectional bottom view showing an optical sensor being mounted in a cover of the moving-loop advertisement display of FIG. 1;

FIG. 5 is a bottom plan view of the driving roller in the moving-loop advertisement display of the present invention;

FIG. 6 is a perspective view of a second embodiment of a moving-loop advertisement display device in accordance with the present invention;

FIG. 7 is a plan view of the moving-loop advertisement display device of FIG. 6;

FIG. 8 is a plan view of a third embodiment of the moving-loop advertisement display device of the present invention;

FIG. 9 is a plan view of a fourth embodiment of the moving-loop advertisement display device of the present invention;

FIG. 10 is a perspective view showing the connection of a motor and a roller in accordance with the present invention;

FIG. 11 is a lateral side plan view showing the moving-loop advertisement display device of FIGS. 1 to 9 of the present invention;

FIG. 12 is a lateral side plan view showing a fifth embodiment of an advertisement display device with three rollers; and

FIG. 13 is a plan view of a conventional advertisement device.

### DETAILED DESCRIPTION OF THE PREFERRED EMBODIMENT

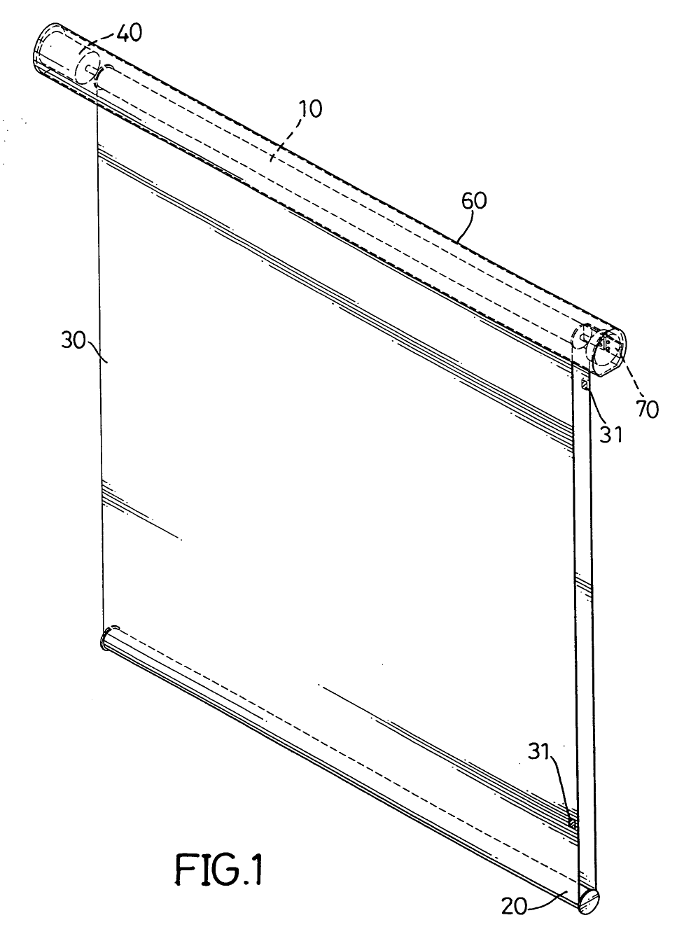

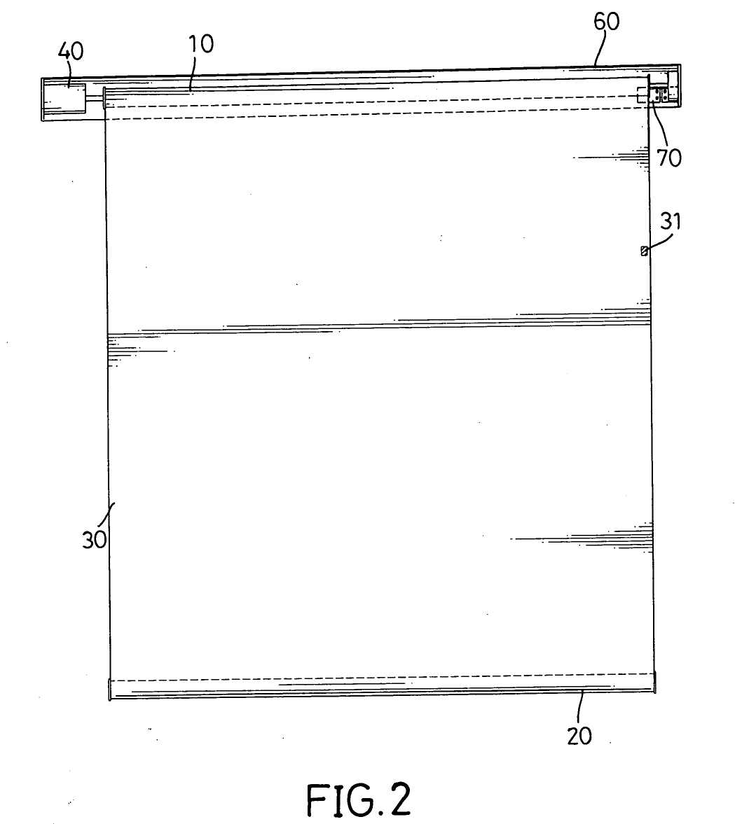

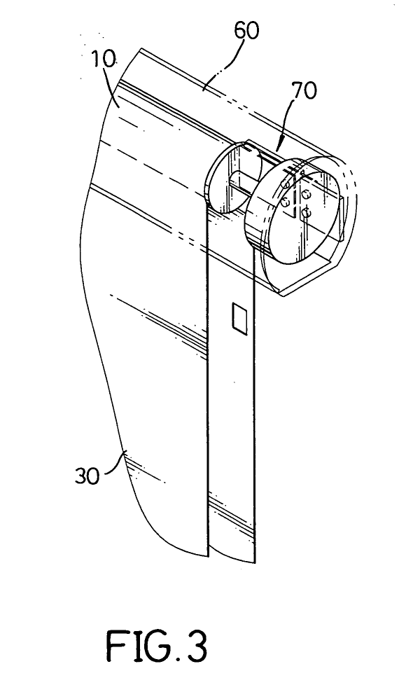

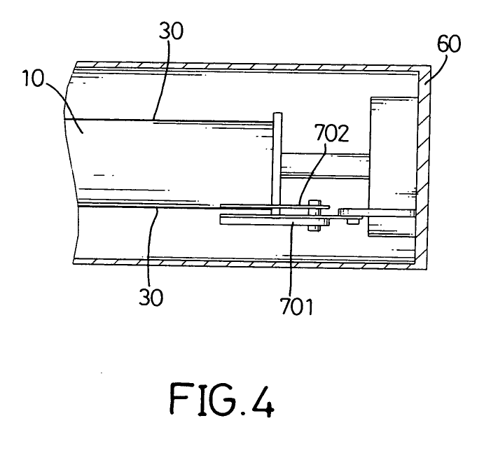

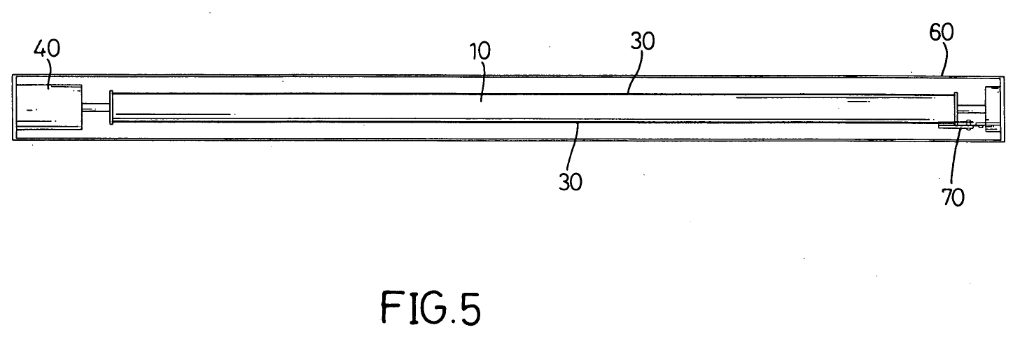

With reference to FIGS. 1-5, a first embodiment of the moving-loop advertisement device in accordance with the present invention comprises a rod assembly, a driving device and a display screen (30). The rod assembly is composed of a driving roller (10) and a driven roller (20) handed by the display screen (30). A motor (40), as the driving device, connects to one end of the upper rod (10) and is able to be automatically and intermittently actuated at predetermined times. A cover (60) is further mounted on the driving roller (10), where said motor (40) is attached to the inner surface of one end of the cover (60). A position sensor (70), for example an optical sensor in this embodiment, is installed in an opposite end of the inner surface of the cover (60) and controlled by a control box disposed in the cover (60). The optical sensor (70) includes a signal emitting element (701) and a signal receiving element (702) apart from the signal emitting element (701). The edge of the display screen (30) is jus positioned between the signal emitting element (701) and the signal receiving element (702) as shown in FIG. 4.

The display screen (30) forms a closed loop and simultaneously surrounds the driving roller (10) and the driven roller (20). Preferably, the display screen (30) is fabricated by a curtain or material pervious to light, on which plural advertisement segments represented by pictures, patterns or text are attached or printed. Several labels (31) are formed along one edge of the display screen (30), where these labels (31) may be created by dark ink printed on the display screen (30).

When the activated motor (40) drives the driving roller (10) to rotate, the driving roller (10) transmits the display screen (30) to move upward, at the same time the driven roller (20) is driven by the display screen (30). At the time that any label. (31) passes through the optical sensor (70), the emitted optical signal is unable to emit through the display screen (30) and obstructed by the label (31) thus generating a signal for pausing the motor (40) with a short term. During the pause period, the display screen (30) could demonstrate a complete advertisement segment.

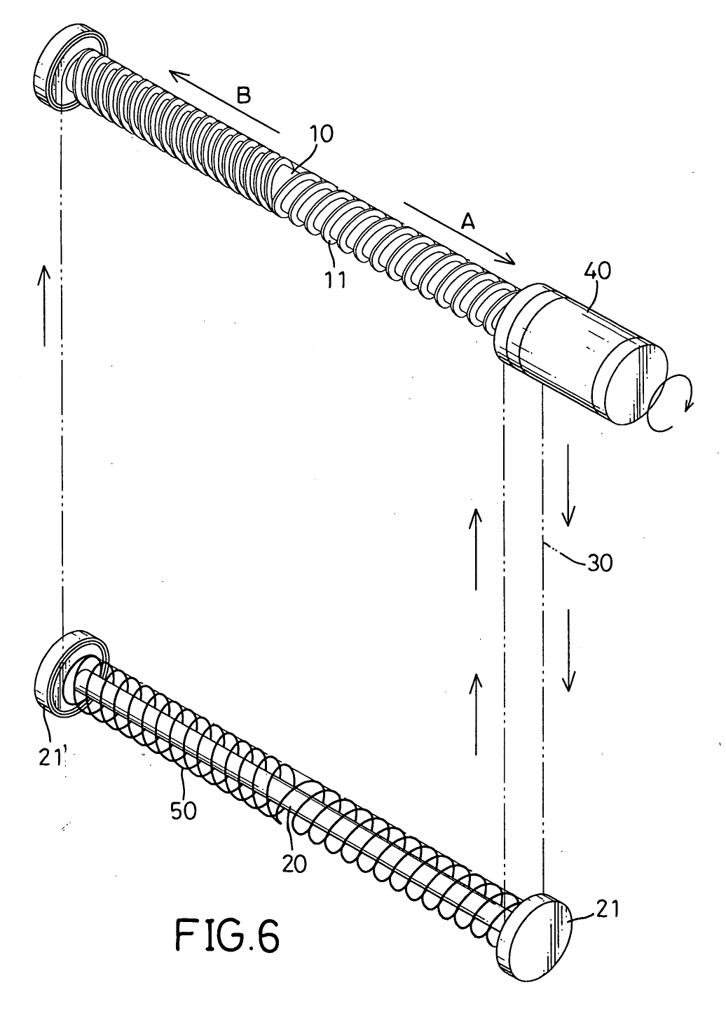

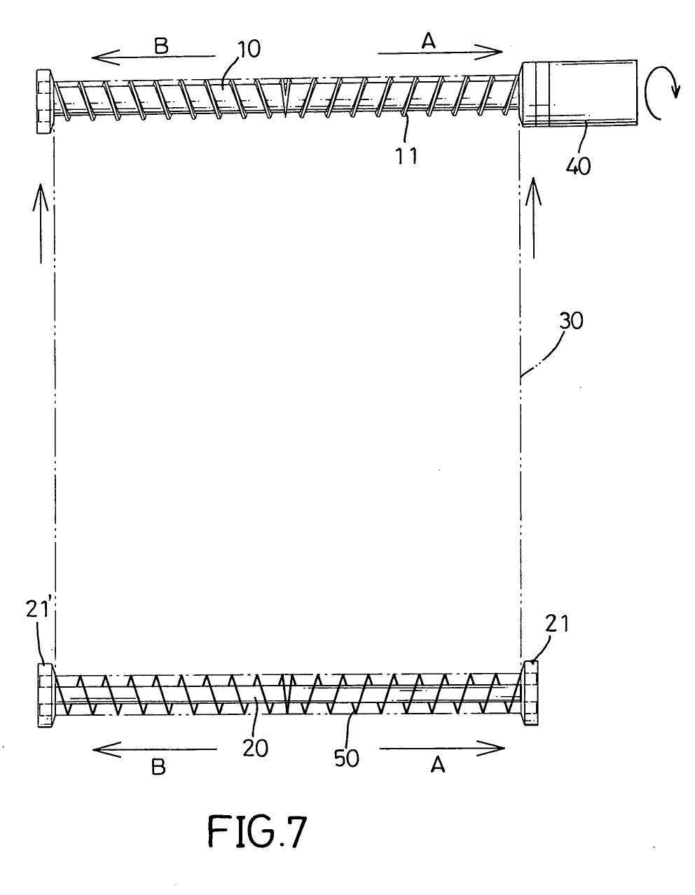

With reference to FIGS. 6 and 7, a second embodiment of the moving-loop advertisement device in accordance with the present invention is substantially the same as the first one. The second embodiment also comprises a rod assembly, a driving device, a display screen (30). A tension adjustment device is further added in the embodiment.

The rod assembly is composed of a driving roller (10) and a driven roller (20). A motor (40), as the driving device, connects to one end of the upper rod (10) and is able to be automatically and intermittently actuated at predetermined times.

The tension adjustment device in the present invention can be implemented by either or both of a coil (50) formed on the driven roller (20) and helical ribs (11) formed on the driving roller (10). The coil (50) is twisted around the driven roller (20), where the two ends of the coil (50) tightly abut against two enlarged distal ends (21)(21′) of the driven roller (20). It is noted that the coil (50) is formed to have two segments with opposite twisting directions, i.e. clockwise and counter-clockwise directions.

The helical ribs (11) are raised from and wound around the surface of the driving roller (10) similar to the thread on a screw but with two portions having opposite winding directions, where the opposite winding directions of the helical ribs (11) are corresponding to the opposite twisting directions of the coil (50) around the driven roller (20).

The display screen (30) forms a closed loop and simultaneously surrounds the driving roller (10) and the driven roller (20). Preferably, the display screen (30) is fabricated by a curtain or translucent thin film etc, on which the desired pictures, patterns or text are attached or printed. Along one edge of the display screen (30), several labels are created.

When the activated motor (40) drives the driving roller (10) to rotate, the driving roller (10) transmits the display screen (30) to move upward, at the same time the driven roller (20) is driven by the display screen (30). Meanwhile, two outward tension forces with opposite directions (denoted with arrows A and B) occur because of the opposite twisting direction of the coil (50) and the helical ribs (11). The opposite forces will gently tug the screen outwardly and keep the surface of the display screen (30) smooth and prevent the occurrence of wrinkles. Preferably, the driving roller (10) is formed with the helical ribs (11) thereon as shown in FIG. 6. However, even when there is only the coil (50) twisted around the driven roller (20) and the driving roller (10) is plain, the coil (50) is still able to generate opposite tension forces to maintain a smooth rolling motion.

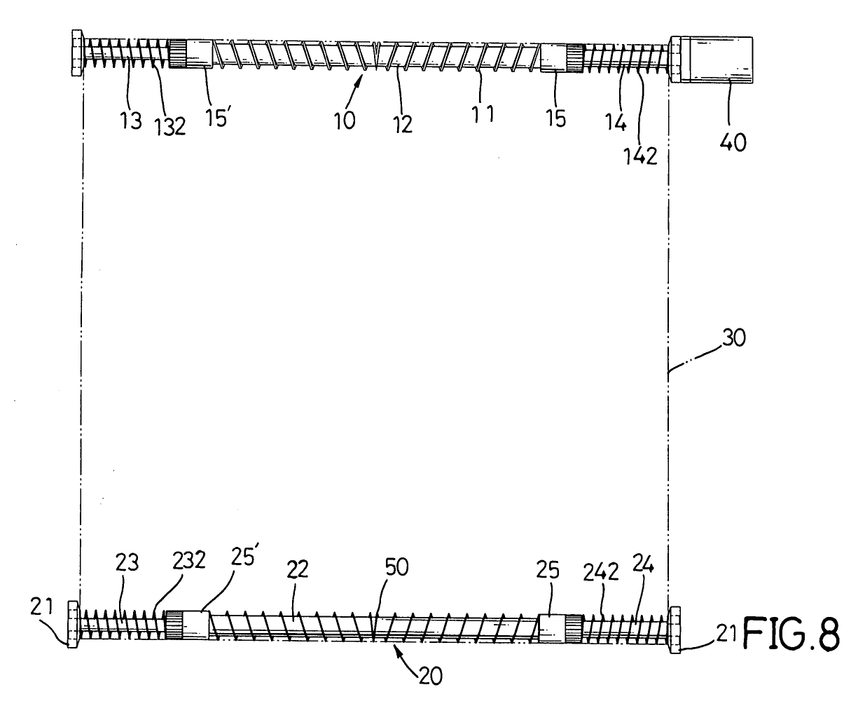

With reference to FIG. 8, the structure of the driving roller (10) and the driven roller (20) are modified to become extendable. The driving roller (10) is composed of a hollow central tube (12) with two openings through which a first rod (13) and a second rod (14) respectively insert into the central tube (12). The joint between the two rods (13) and the central tube (12) is through the use of two well known bushings (15)(15′). By rotating either of the bushings (15)(15′), the respective rod (13)(14) is released from the central tube (12) so that the rod (13)(14) can be pulled out from or pushed into the central tube (12). Through the foregoing adjustment, the length of the driving roller (10) can meet the desired specification.

The helical ribs (11), with opposite winding directions, are still formed on the surface of the hollow central tube (11). However, it is noted that a first coil (132) and a second coil (142) respectively wind around the first rod (13) and the second rod (14). Further, the twisting direction of the first coil (132) is the same as that of the left half portion of the helical ribs (11) near the first coil (13). Similarly, the right half portion of the helical ribs (11) and the second coil (142) have the same winding direction.

The driven roller (20) is substantially the same as the driving roller (10) of FIG. 6, where the modification is that the helical ribs (11) are replaced with the coil (50) winding around the central tube (22). The twisting directions of the left and right half parts of the coil (50) are respectively the same as the first coil (232) and the second coil (242).

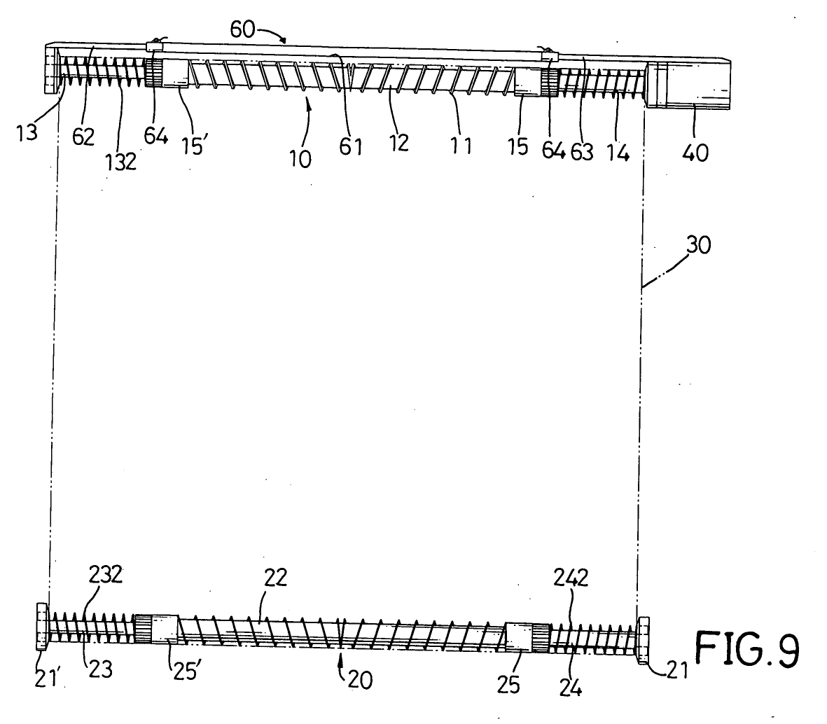

With reference to FIG. 9, the cover (60) is mounted on the driving roller (10). Since the length of the driving roller (10) is adjustable, the cover (60) is constructed by a center segment (61) and two extendable segments (62)(63) each of which movably extends from one end of center segment (61) and is secured via a fastener (64).

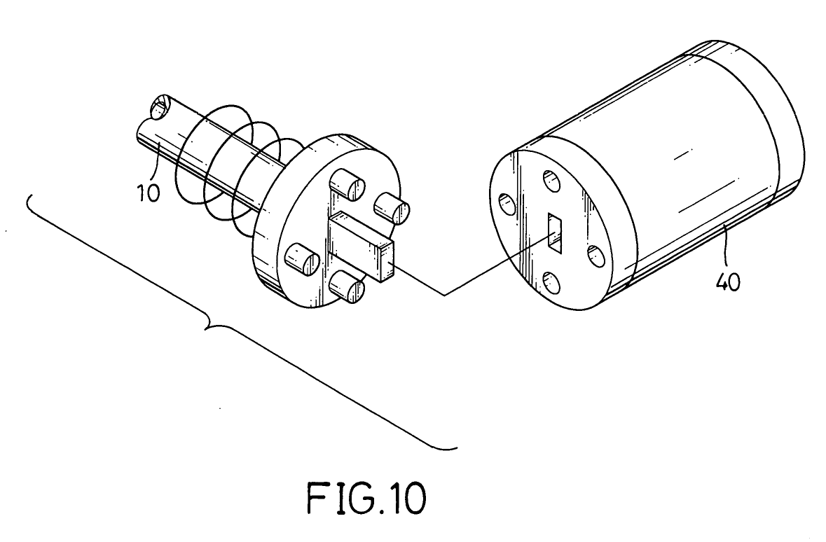

With reference to FIG. 10, as mentioned above, the motor (40) is able to connect to the driving roller (10) as shown in FIG. 6 or to the rod (14) as shown in FIG. 8. For whichever embodiment, the end of the roller (10) or rod (14) for connection to the motor (40) is formed as an enlarged end from which several protrusions are provided to insert in holes on the motor (40).

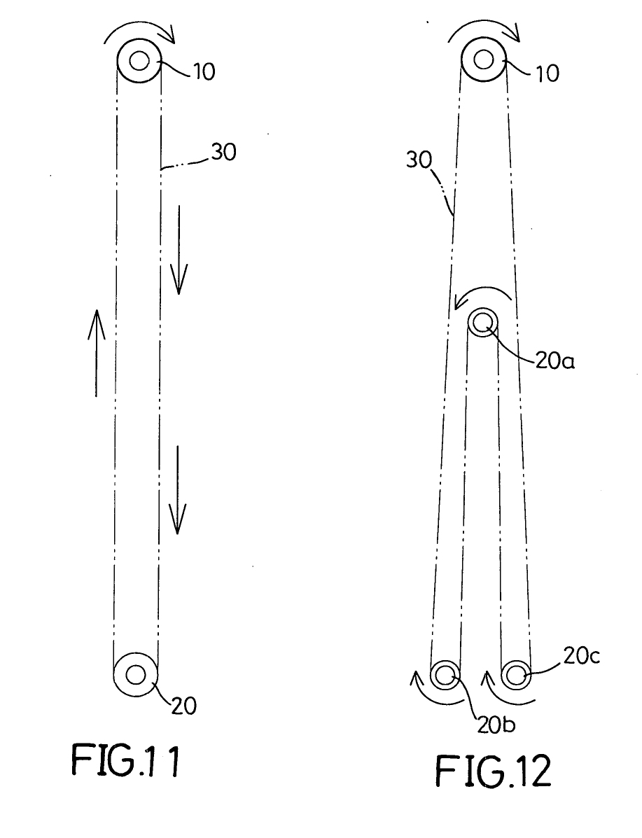

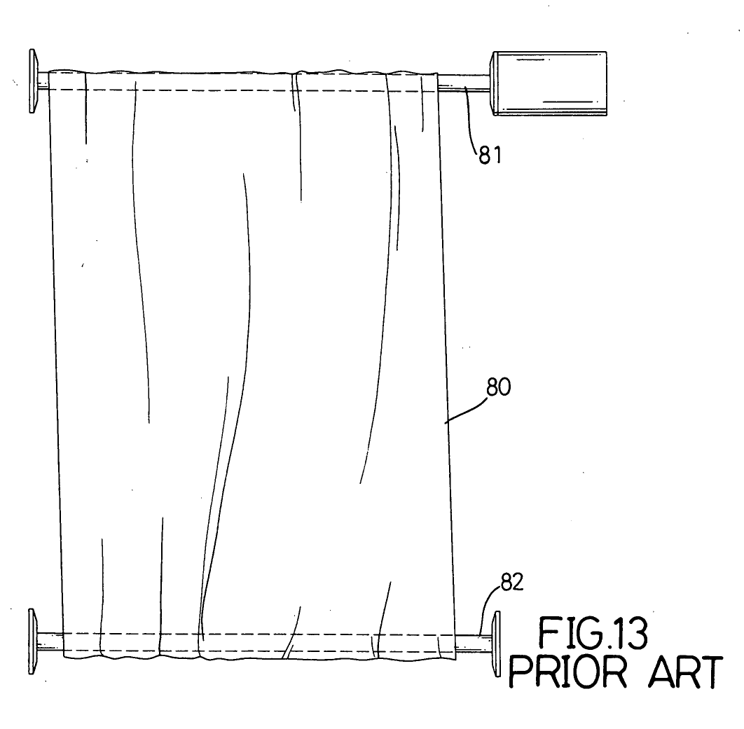

The lateral view for each foregoing embodiment is illustrated and schematically presented in FIG. 11. However, with reference to FIG. 12, the single driven roller (20) is replaced with three driven rollers (20a, 20b and 20c) configured to form a triangular arrangement. Two rollers (20b, 20c) placed in parallel are at the lowest position, and the other one (20a) is placed between the driving roller (10) and the two lowest rollers (20b, 20c). The display screen (30) sequentially passes through the driving roller (10), one of the two lowest rollers (20c), the middle roller (20a), the other one of the two lowest rollers (20b) and then back to the driving roller (10). The purpose of such an arrangement is to increase the length of the display screen (30) thus allowing more advertisement information been formed thereon.

In conclusion, the present invention utilizes the helical ribs (11) or the coil (50) with opposite winding directions as a spiral transmission means to generate opposite tension forces. The tension forces with opposite directions will keep the surface of the rolling screen (30) in a smooth flat status while the screen is rolling. Such a transmission means may be provided on either of the driving roller (10) or the lower roller (20), or preferably on both.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A moving-loop advertisement device comprising:
a cover;
a driving roller mounted in said cover;
three driven rollers configured to form a triangular arrangement, wherein two driven rollers placed in parallel are at the lowest position, and the other one is placed between the driving roller and the two lowest driven rollers;
a driving device for driving said driving roller to rotate;
a display screen passing through the driving roller, one of the two lowest rollers, the middle roller, the other one of the two lowest rollers and then back to the driving roller, wherein advertisement sections are provided on the rolling screen and plural labels are formed along one edge of the display screen;
a position sensor mounted in said cover and emitting signals to detect whether any label passes through the position sensor;
wherein when any label passes through the position sensor, said driving device is paused to stop the rotation of the display screen thus to demonstrate one complete advertisement section.

2. The moving-loop advertisement device as claimed in claim 1, wherein said position sensor is an optical sensor.

3. The moving-loop advertisement device as claimed in claim 2, wherein the advertisement device further has a tension adjustment device provided on the driving roller and the three driven rollers to apply outward tension forces with opposite directions on the rolling screen, wherein when the display screen is rolling, the applied opposite tension forces maintain a surface of the display screen smooth.

4. The moving-loop advertisement device as claimed in claim 3, wherein said tension adjustment device is a coil formed by two segments both twisted around one of the three driven rollers, where the two segments have opposite twisting directions.

5. The moving-loop advertisement device as claimed in claim 4, wherein two distal ends of the coil respectively abut against two enlarged ends of the one of the three driven rollers.

6. The moving-loop advertisement device as claimed in claim 3, wherein said tension adjustment device is helical ribs integrally raised from and wound around one of the driving roller, where the helical ribs are divided into two groups with opposite winding directions on the one of the driving and three driven rollers.

7. The moving-loop advertisement device as claimed in claim 1, wherein the driving device is a motor.

8. The moving-loop advertisement device as claimed in claim 2, wherein the driving device is a motor.

9. The moving-loop advertisement device as claimed in claim 3, wherein the driving device is a motor.

10. The moving-loop advertisement device as claimed in claim 4, wherein the driving device is a motor.

11. The moving-loop advertisement device as claimed in claim 5, wherein the driving device is a motor.

12. The moving-loop advertisement device as claimed in claim 6, wherein the driving device is a motor.
